(19) United States
(12) Patent Application Publication
(10) Pub. No.: US 2015/0066700 A1
(43) Pub. Date: Mar. 5, 2015

(54) COMPUTER BASED, USE-ORIENTED INFORMATION GENERATION AND MODIFICATION FOR PRODUCTS AND SERVICES

(71) Applicant: International Business Machines Corporation, Armonk, NY (US)

(72) Inventors: Gregory J. Boss, Saginaw, MI (US); Andrew R. Jones, Round Rock, TX (US); C. Steven Lingafelt, Durham, NC (US); Kevin C. McConnell, Austin, TX (US); John E. Moore, Jr., Brownsburg, IN (US)

(73) Assignee: International Business Machines Corporation, Armonk, NY (US)

(21) Appl. No.: 14/038,895

(22) Filed: Sep. 27, 2013

Related U.S. Application Data
(63) Continuation of application No. 14/012,507, filed on Aug. 28, 2013.

(51) Int. Cl. G06Q 30/06

(52) U.S. Cl. CPC G06Q 30/0623
USPC 705/26.61

(57) ABSTRACT

A method or apparatus for generating or modifying use-oriented information may include stored information regarding general and detailed product information. An information processor may receive additional information regarding an individual user or consumer of the product, as well as the particular context in which the product is used by the individual. Based at least on the received use context, the information processor may select or modify relatively specific product-related or service-related information, personalized or tailored to the individual's particular use of the product. The resulting use-oriented information may be sent to the individual by way of a telecommunications network or other suitable means.

### CROSS-REFERENCE TO RELATED APPLICATION

This application is a continuation of U.S. Patent Application Ser. No. 14/012,507, filed Aug. 28, 2013, the disclosure of which is incorporated by reference herein in its entirety.

### BACKGROUND

The present invention relates to tailoring product or service information, and more specifically, to generating and modifying use-oriented information related to a product or service for presentation to a user or consumer.

Manufacturers, distributors and retailers of consumer products and services conventionally maintain private information and the products they purchase. For example, when a consumer purchases a product such as a car, a car dealer may collect information from the consumer, which may be forwarded to the automobile manufacturer or an associated distributor. The information may be manually keyed in or otherwise delivered in digital format to a database of the manufacturer, where it may be stored.

Information related to the product may be unknown to the consumer. From time to time, information from the manufacturer, distributor or retailer could be useful to the consumer. For example, at some point in time the purchaser of an automobile may be interested in the warranty term remaining on the purchased vehicle.

With the advent of the Internet, information portals have been provided to supply some general information to customers. Conventional information portals are designed to provide some general information to consumers in a generalized format. Conventionally, some portals may request user profile information from a user to categorize the user as belonging to a particular group or profile. Based on the user's profile, a web portal such may deliver general information to the user. For example, if the user provides to the portal that the user is interested in a particular stock, then the portal may deliver articles about that particular stock to the user. This information is broadcast to all consumer users identifying an interest in Microsoft stock. Another example of information that is conventionally provided is general weather information. For example, a user may enter a city of interest and the portal broadcasts weather information to the user and others who have stated an interest in the same city.

### SUMMARY

According to one embodiment of the present invention, a system for generating or modifying use-oriented information may include an information storage device configured to store product information, and an information processor configured to receive a use context definition and to select the use-oriented product information, based at least in part on the use context, from the product information.

According to other embodiments, the information processor may be further configured to receive a product identification and select the use-oriented product information based at least in part on the product identification, receive a user identification and select the use-oriented product information based at least in part on the user identification, receive a user preference and select the use-oriented product information based at least in part on the user preference, and send the use-oriented product information to a user device.

According to another embodiment of the present invention, a computer program product for generating or modifying use-oriented information may include a computer readable storage medium having stored thereon program instructions executable by a processor to cause the processor to receive a use context, and to select use-oriented product information based at least in part on the use context.

According to other embodiments, the computer readable storage medium may further have stored thereon program instructions executable by the processor to cause the processor to receive a product identification and select the use-oriented product information based at least in part on the product identification, receive a user identification and select the use-oriented product information based at least in part on the user identification, receive a user preference and select the use-oriented product information based at least in part on the user preference, and send the use-oriented product information to a user device.

According to another embodiment of the present invention, a method for generating or modifying use-oriented information may include receiving a use context and selecting use-oriented product information, based at least in part on the use context.

According to other embodiments, the method may include receiving a use context and selecting the use-oriented product information, based at least in part on the use context, receiving a product identification and selecting the use-oriented product information based at least in part on the product identification, and sending the use-oriented product information to a user device.

According to other embodiments, the use context may include at least one of a location, an altitude indication, a climate definition, a season indication, a weather condition, an environment condition, an ambient temperature condition, an ambient pressure condition, a time indication, a product use combination. In one embodiment, the use-oriented product information comprises a product use instruction.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of an apparatus for generating and modifying use-oriented information in accordance with an embodiment of the invention.

FIG. 2 is a schematic diagram of an apparatus for generating and modifying use-oriented information in accordance with an embodiment of the invention.

FIG. 3 is a schematic diagram of an apparatus for generating and modifying use-oriented information in accordance with an embodiment of the invention.

FIG. 4 is a flow diagram of a method for generating and modifying use-oriented information in accordance with an embodiment of the invention.

FIG. 5 is a flow diagram of a method for generating and modifying use-oriented information in accordance with an embodiment of the invention.

FIG. 6 is a flow diagram of a method for generating and modifying use-oriented information in accordance with an embodiment of the invention.

### DETAILED DESCRIPTION

In many cases more specific, personalized information would be useful to consumers and users of a product. An improved method and apparatus for providing such information would benefit product consumers and users.

An embodiment of the present invention may provide relatively specific product or service information, personalized or tailored to an individual consumer or user of the product and/or to the specific context in which the product or service is used. For example, an embodiment of the present invention may provide use-oriented information tailored to the needs or preferences of an individual user or consumer of a particular product or service.

In particular, an embodiment of the present invention may collect use context information specific to an individual user or consumer of a particular product or service. In addition, use context information regarding the environment in which the product or service is or will be used may be collected. Based on the collected use context information, known or available product-related or service-related information may be selected or modified in order to generate use-oriented information tailored not only to the individual user's or consumer's specific needs and preferences, but also tailored to the specific environment in which the individual user will use the product or service. The selected or modified use-oriented information may be delivered directly to the individual user by any convenient means.

In this manner, specific, personalized, use-oriented information related to a particular product or service may be provided to an individual user or consumer. The use-oriented information may be selected or modified based on use context information, for example, including environmental conditions or factors currently prevailing at the place and time of product use or service receipt by an individual user or consumer. Such environmental conditions or factors may include, for example, the location where the product is used or the service is received, including the altitude at the location, current local weather conditions, time of day, or any other environmental condition or factor that may be relevant to the use of the product or service.

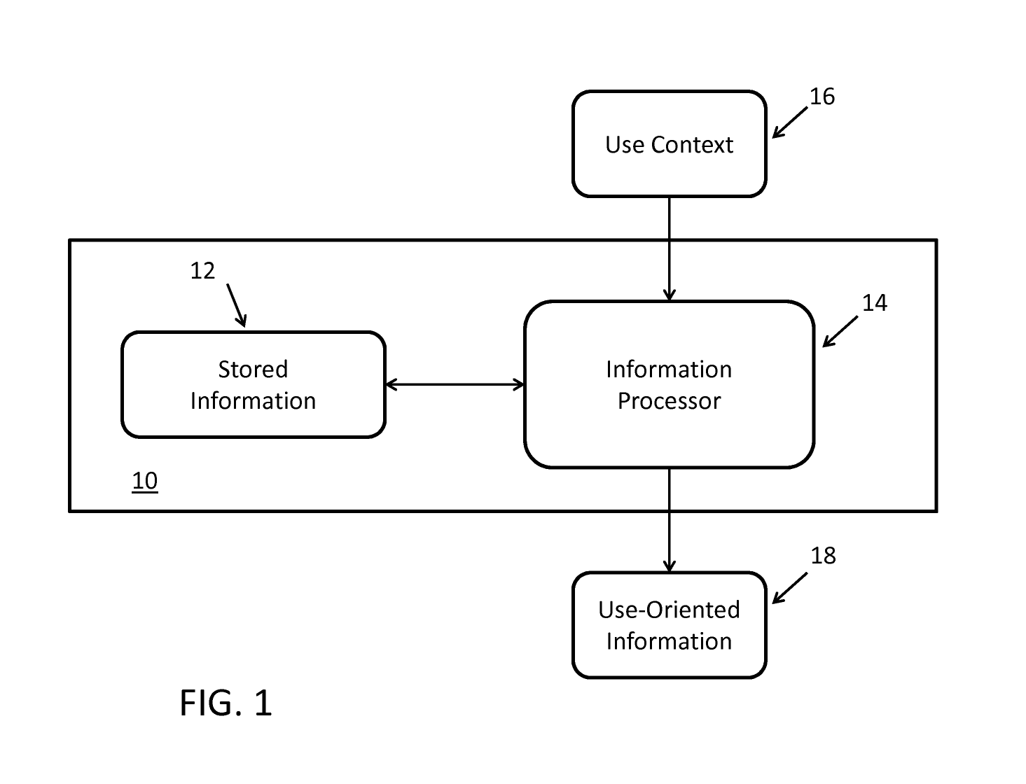

With reference now to FIG. 1, an embodiment in accordance with the present invention will be described. A use-oriented information generation and modification apparatus 10 may include stored information 12, for example, information stored in a format that may be electronically, magnetically or optically detected and read by a computer device. The use-oriented information generation and modification apparatus 10 may also include an information processor 14 associated with the stored information 12 and configured to send and receive information to and from the stored information 12.

The information processor 14 may be configured to receive information regarding use context 16, for example, from a product user or consumer, from a service customer, from a user device, or from a product manufacturer, distributor, retailer, or other entity having information regarding, for example, a product user or the environment in which the product is used. In some embodiments, the information processor 14 may send some or all of the use context 16 to the stored information 12 for temporary, short-term, long-term or permanent storage. For example, the use context 16 may be maintained for use in future interactions regarding the same user or consumer.

The information processor 14 may be configured to select relevant information or modify general information from the stored information 12 in order to generate or modify use-oriented information 18 based on the received use context 16. The use-oriented information 18 may be tailored, for example, to the specific needs or preferences of an individual user or consumer, or to specific environmental conditions or factors regarding, for example, the place and time of product use or receipt of service.

As a more specific example, the use-oriented information generation and modification apparatus 10 may receive, for example, location information regarding the specific location at which a product user, a baker, is baking a cake using a particular cake mix previously purchased by the product user. The location information may include the altitude of the use location, for example, in units of feet or meters above sea level, or the location information may provide information that allows the information processor 14 to determine the altitude of the use location, for example, by accessing and correlating stored information 12 in the form of a stored table or chart.

In this example, the user or consumer is the original product purchaser or buyer, but one of average skill in the art will readily apprehend that in various examples the user or consumer and the original product purchaser or buyer could be the same individual or separate individuals, or that the product purchaser or buyer could at one point in time also be the product user or consumer, but at another point in time another individual could become, temporarily or indefinitely, the user of consumer of the same instance of the product or service.

Having received or determined the altitude of the use location—for purposes of this example, say, an altitude of 5,280 feet above sea level in or near the city of Denver in the state of Colorado—the information processor 14 may select detailed information from among the stored information 12, for example, based on the relevance of the detailed information with regard to the received or determined altitude of 5,280 feet above sea level and the purchased cake mix. The selected or modified detailed information may be organized or formatted to create use-oriented information 18 that may be sent to the baker.

For example, in general, the optimal baking time for a cake made with a particular cake mix may vary depending on the altitude at which the cake is baked, because the boiling point of water varies indirectly proportionately to ambient pressure, which typically decreases with altitude. Thus, in order to produce an optimal cake, the cooking time may be altered based on the ambient altitude at the location where the cake is baked. In this example, the use-oriented information generation and modification apparatus 10 may, for example, select the optimal cooking time from a stored table of cooking times. That is, the information processor 14 may select a relatively optimal cooking time from a table of cooking times in the stored information 12.

Alternatively, in some embodiments, the use-oriented information generation and modification apparatus 10 may modify general information with specific details relevant to use context to create use-oriented information 18. For example, the information processor 14 may determine an appropriate cooking time offset by extrapolating between two or more data points of a stored chart in the stored information 12 based on the altitude of the use location. Thus, in a specific instance, the information processor 14 could extrapolate between an offset of negative ten minutes for an altitude of 5,000 feet above sea level and negative fifteen minutes for an altitude of 6,000 feet above sea level to determine an optimal offset of negative eleven and four-tenths minutes at 5,280 feet. The offset may be applied to a general cooking time, for example, based on standard conditions at sea level.

Having selected or determined the optimal cooking time based on the altitude of the use location, in this example the apparatus 10 may create use-oriented information 18 in the form of cooking instructions. For example, the information processor 14 may format and send use-oriented information 18 to the baker in the form of altitude-specific cooking instructions based on the received or determined use context 16 (5,280 feet above sea level). That is, the use-oriented information generation and modification apparatus 10 may send the baker specific, personalized baking instructions for the particular cake mix including the relatively optimal cooking time for an altitude of 5,280 feet above sea level. For example, if the recommended cooking time for standard conditions at sea level is one hour, the use-oriented information 18 may specify a recommended cooking time of 58.6 minutes based on the baker's use context 16.

In another specific example, the use-oriented information generation and modification apparatus 10 may provide individually-tailored cooking instructions for a purchased microwavable entrée to an individual. In this example, the information processor 14 may receive use context 16 including the power capacity of the microwave oven used to cook the entrée. For example, the individual in this example may have a home kitchen microwave oven with a relatively high rated power capacity of 1,400 Watts (W) and a secondary media room microwave oven with a relatively low rated power capacity of 700 W.

The individual may send and the information processor 14 may receive use context 16 indicating the power capacities of the individual's two microwave ovens, and the information processor 14 may send the two power settings to the stored information 12 for later use when the individual requests cooking instructions for the purchased entrée. At a later time, the individual may send and the information processor 14 may receive further use context 16 indicating that the individual wishes to heat the entrée in the secondary recreation room microwave oven.

The information processor 14 may access the stored information 12, which may include product information regarding the manufacturer recommended cooking time, to select or determine a relatively optimal cooking time for the purchased entrée using the relatively low-powered microwave. For example, in some embodiments, based on stored information 12 recommending a cooking time of four minutes using a microwave oven having a power capacity of 1,100 W, the information processor 14 may calculate a modified recommended cooking time of four-and-a-half minutes using a microwave oven with a rated power capacity of 700 W.

The information processor 14 may prepare and send to the individual, based on the received use context 16 including the power setting of the individual's microwave ovens and which microwave oven the individual plans to use in a specific instance, individualized use-oriented information 18 in the form of cooking instructions for the entrée, including a recommended cooking time of four-and-a-half minutes.

A person of ordinary skill in the art will readily apprehend that an embodiment of the present invention may be used with various complementary technologies that will enhance the user experience. For example, radio frequency identification (RFID) tags on the two microwave ovens and on the microwavable entrée in the immediate example would facilitate use of an RFID sensor to automatically detect the specific microwave oven and purchased entrée. Similarly, voice recognition technology combined with mobile telecommunications technology would facilitate the individual's use of a voice command to conveniently request and receive timely, individualized use-oriented cooking instructions at the point of use of the purchased entrée.

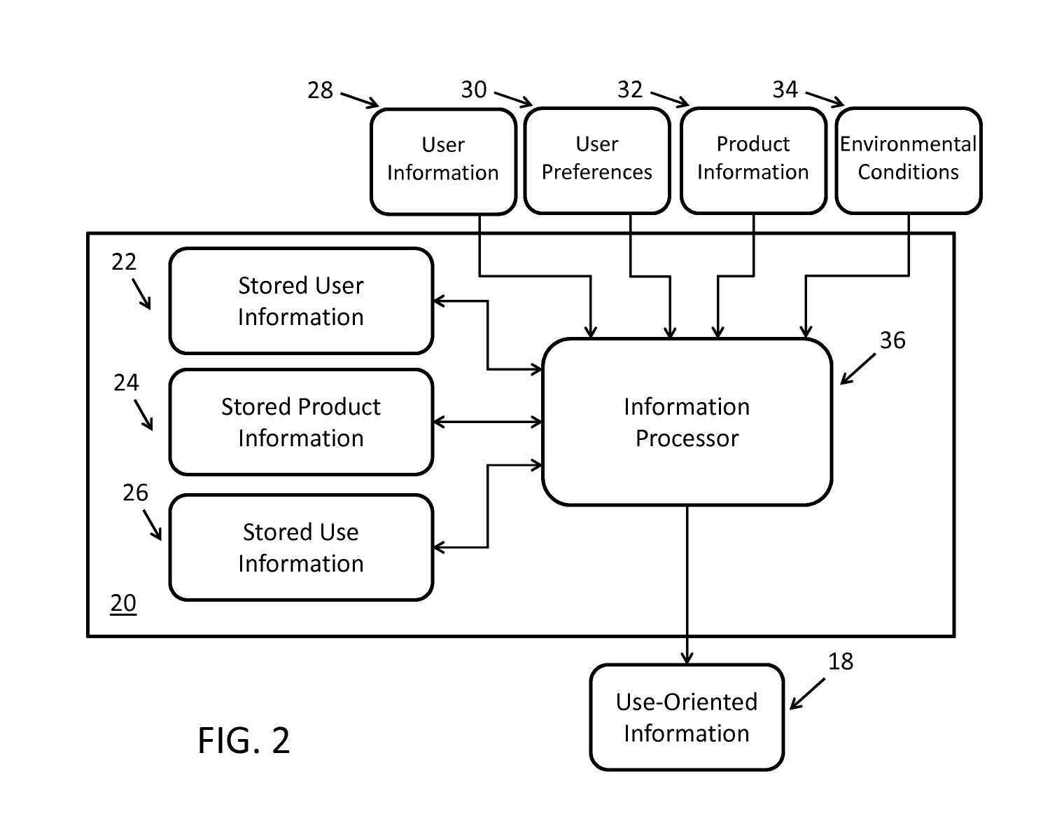

FIG. 2 discloses another embodiment of a use-oriented information generation and modification apparatus 20, including an information processor 36, as before. This apparatus 20 includes stored user information 22, stored product information 24 and stored use information 26, each of which may be stored, for example, in a computer-readable medium in a format that may be electronically, magnetically or optically detected and read by a computer device, such as magnetic tape, a disk drive, a compact disk, a removable flash drive, or any other acceptable memory means.

For example, the stored user information 22 in an embodiment may include personal data as a product purchaser's name, home address, and phone number, demographic information, as well as the purchaser's user preferences related to a purchased product. In some embodiments, the stored user information 22 may also include personal data with respect to one or more other individuals who may be alternate users of the purchased product. For example, the stored user information 22 may include multiple unique user profiles, each including individual personal data and user preferences with respect to each member of a family.

In an embodiment of the present invention, the stored user information 22 may be supplied to the use-oriented information generation and modification apparatus 20 directly by the purchaser or user(s). In alternative embodiments, the stored user information 22 may be provided by a retailer, service provider, distributor, agency, governmental entity, nonprofit entity or other associated or interested person or entity having relevant information about the purchaser or other user(s). In some embodiments, at least some of the stored user information 22 may be provided by way of an automated system utilizing complementary technologies, for example, the RFID, voice recognition, and telecommunication, such as described in the example above.

The stored product information 24 may include, for example, product use instructions, maintenance recommendations or requirements, product warranty information, service options, or the like. IN an embodiment, the stored product information 24 may include variable or alternative product information, or multiple variations or alternatives relevant to the product. In some embodiments, the stored product information 24 may include thresholds, predetermined levels or limits related to specific product information variables or alternatives, which may be used by the information processor 36 in selecting or determining detailed information relevant to use conditions.

In an embodiment of the present invention, the stored product information 24 may be provided to the use-oriented information generation and modification apparatus 20 directly by the product manufacturer or service provider. In alternative embodiments, the stored product information 24 may be supplied by a retailer, service provider, distributor, agency, governmental entity, nonprofit entity, purchaser, user or other associated or interested person or entity having relevant information about the purchaser or other user(s). In some embodiments, at least some of the stored product information 24 may be provided by way of an automated system utilizing complementary technologies, for example, the RFID, voice recognition, and telecommunication, such as described in the example above.

The stored use information 26 may include for example, environmental conditions or factors currently prevailing at the place and time of product use or service receipt by an individual user or consumer. Such environmental conditions or factors may include, for example, the location where the product is used or the service is received, including the altitude at the location, current local weather conditions, time of day, or the like.

In an embodiment of the present invention, the stored use information 26 may be directly supplied to the to the use-oriented information generation and modification apparatus 20 by the purchaser or user(s). In alternative embodiments, the stored use information 26 may be provided by a retailer, service provider, distributor, agency, governmental entity, nonprofit entity or other associated or interested person or entity having relevant information about the purchaser or other user(s). In some embodiments, at least some of the stored use information 26 may be provided by way of an automated system utilizing complementary technologies, for example, the RFID, voice recognition, and telecommunication, such as described in the example above.

The information processor 36 of the use-oriented information generation and modification apparatus 20 may be configured to receive user information 28, user preferences 30, product information 32 and environmental conditions 34. This received information taken together may provide useful context regarding the use of a particular product or service by a user or consumer, or use context, which may be used by the information processor to create use-oriented information 18 for the user or consumer.

In some embodiments, the information processor 36 may send some or all of the user information 28, user preferences 30, product information 32 and environmental conditions 34 to the stored user information 22, stored product information 24 or stored use information 26 for temporary, short-term, long-term or permanent storage. For example, in any embodiment of the present invention a portion of the user information 28 and/or the user preferences 30 may be maintained in the stored user information 22 for use in future interactions regarding the same user or consumer. Similarly, in any embodiment a portion of the product information 32 may be maintained in the stored product information 24 for use in future interactions regarding the same product or service. In like manner, in any embodiment a portion of the environmental conditions may be maintained in the in the stored use information 26 for use in future interactions occurring in the same or similar use context.

The information processor 36 may be configured to select relevant information or modify general information from each the stored user information 22, the stored product information 24 and the stored use information 26 in order to generate or modify use-oriented information 18 based on the received user information 28, user preferences 30, product information 32, environmental conditions 34, as well as on the stored user information 22 stored product information 24, and the stored use information 26. As in the embodiment of FIG. 1, the use-oriented information 18 may be tailored, for example, to the specific needs or preferences of an individual user or consumer, or to specific environmental conditions or factors regarding, for example, the place and time of product use or receipt of service.

In a more specific example, the use-oriented information generation and modification apparatus 20 may receive, for example, location information regarding the specific location at which a product user, a medical patient who has purchased for personal use a topical prescription drug dispensed in a cream. In this example the efficacy of the topical drug may decrease with increased exposure to sunlight.

Based on the received use location, current weather conditions at the location, and the day of the year, for example, the information processor 36 may determine the daily hours of sunlight and the intensity of sunlight at the location on that date. From this information, the information processor 36 may estimate the patient's anticipated exposure to sunlight during the day and formulate use-oriented information 18, for example, based on a table in the stored product information 24 relating the topical drug's efficacy to sunlight exposure. The table in the stored product information 24 may further include a threshold value. For example, the table in this example may include a threshold value of three hours per day exposure to sunlight, over which it is recommended the user apply sunscreen.

In this example, the information processor 36 may determine an anticipated exposure of three-and-a-half hours to sunlight, and for example, select detailed information or modify generalized information, as discussed above, from the stored product information 24 in order to formulate resulting use-oriented information 18 including individualized instructions for the patient recommending he or she apply sunscreen with a minimum rated ultraviolet protection factor (UPF) or sun protection factor (SPF) of 25 approximately thirty minutes after applying the topical drug. The information processor 36 may format or organize the use-oriented information 18 for transmission to the patient.

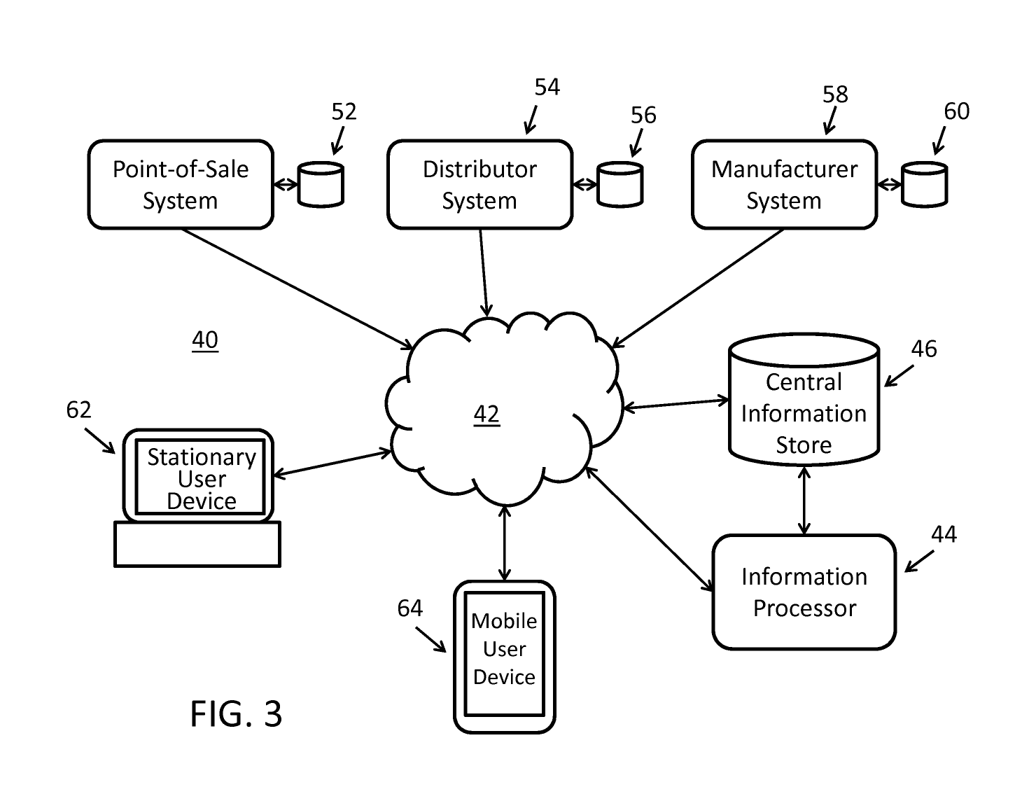

FIG. 3 discloses another embodiment of a use-oriented information generation and modification apparatus 40, in which the various components are interconnected by a network 42 of communications systems. The network 42 may include, for example, a local area network (LAN), such as an Ethernet connection, a wide area network (WAN), the Internet, a private or public telecommunications network, or any combination of these or other communications network systems that may provide for communications between digital devices.

The apparatus 40 may include an information processor 44 and central information store 46, such as a database. In various embodiments, the information processor may be configured to communicate with the central information store 46 by way of a dedicated link 48 only, by way of the network 42 only, or by way of both a dedicated link 48 and the network 42. Further, in various embodiments, the central information store 46 may include a single integral information store or multiple distributed information stores.

The use-oriented information generation and modification apparatus 40 may further include, for example, a point-of-sale system 50, a distributor system 54, a manufacturer system 58, a stationary user device 62 and a mobile user device 64.

The point-of-sale system 50 may be configured, for example, to receive from and send to the information processor 44 by way of the network 42 information such as, for example, a user or consumer profile, user preferences, a purchaser or buyer identification, a retailer identification, a distributor identification, a manufacturer identification, a product identification, a service identification, or any other information available at the point-of-sale of a product or service. The apparatus 40 may further include a local information store 52, such as a database, associated with the point-of-sale system 50, and the point-of-sale system 50 may be further configured to send the same or other information to and receive the same or other information from the local information store 52.

Similarly, the distributor system 54 may be configured, for example, to receive from and send to the information processor 44 by way of the network 42 information such as, for example, a user or consumer profile, user preferences, a purchaser or buyer identification, a retailer identification, a distributor identification, a manufacturer identification, a product identification, a service identification, general or detailed product-related or service-related information, or any other information available to a distributor of a purchased product or service. The apparatus 40 may further include a local information store 56, such as a database, associated with the distributor system 54, and the distributor system 54 may be further configured to send the same or other information to and receive the same or other information from the local information store 56.

In a similar manner, the manufacturer system 58 may be configured, for example, to receive from and send to the information processor 44 by way of the network 42 information such as, for example, a user or consumer profile, user preferences, a purchaser or buyer identification, a retailer identification, a distributor identification, a manufacturer identification, a product identification, a service identification, general or detailed product-related information, or any other information available to a distributor of a purchased product or service. The apparatus 40 may further include a local information store 60, such as a database, associated with the manufacturer system 58, and the manufacturer system 58 may be further configured to send the same or other information to and receive the same or other information from the local information store 60.

The stationary user device 62 may include, for example, a personal desktop computer or any other digital computing device with a relatively fixed or limited location of use, such as a laptop computer, which may be configured, for example, to receive from and send to the information processor 44 information such as, for example, a user or consumer profile, user preferences, a purchaser or buyer identification, a retailer identification, a distributor identification, a manufacturer identification, a product identification, a service identification, general or detailed product-related information, or any other information available to a user or consumer of a purchased product or service.

The stationary user device 62 may also be configured to send to the information processor 44 by way of the network 42 use context information and a user request, for example, a request for use-oriented information. The stationary user device 62 may be further configured to receive a request acknowledgement and use-oriented information in response to the request.

The mobile user device 64 may include, for example, a mobile telephone, such as a cellular system telephone or a satellite telephone, a notepad computing device, a tablet computing device, or any other relatively mobile or wireless digital computing device, which may be configured, for example, to receive from and send to the information processor 44 information such as, for example, a user or consumer profile, user preferences, a purchaser or buyer identification, a retailer identification, a distributor identification, a manufacturer identification, a product identification, a service identification, general or detailed product-related information, or any other information available to a user or consumer of a purchased product or service.

The mobile user device 64 may also be configured to send to the information processor 44 by way of the network 42 use context information and a user request, for example, a request for use-oriented information. The stationary user device 62 may be further configured to receive a request acknowledgement and use-oriented information in response to the request.

As a more specific example of the operation of the use-oriented information generation and modification apparatus 40, the purchase and use of a particular model automobile from a particular manufacturer may be considered. In this example, the point-of-sale system 50 may receive user information, such as, for example, the vehicle purchaser's name, home address and phone number; information regarding the retailer, such as, for example, the car dealer that sold the vehicle to the purchaser, and the city and state where the dealer is located; as well as purchase-specific information, such as, for example, the date of sale, and details regarding any extended warranty service agreement purchased with respect to the vehicle.

The point-of-sale system 50 may, for example, send the user information and the purchase-specific information to the local information store 52 for future reference. The point-of-sale system 50 may also, for example, send the user information, the retailer information and the purchase-specific information directly to the central information store 46 by way of the network 42, or to the information processor 44 by way of the network 42 to be saved in the a database of the central information store 46, where the user information, the retailer information and the purchase-specific information may be maintained for future reference.

Alternatively, the point-of-sale system 50 may send a portion or all of the user information, the retailer information and the purchase-specific information to the distributor system 54 by way of the network 42, which may save the information to a database in the associated local information store 56 for future reference and for data redundancy. In some embodiments, the distributor system 54 may forward the received information to the information processor 44 or to the central information store 46.

Similarly, either the point-of-sale system 50 or the distributor system 54 may send a portion or all of the user information, the retailer information and the purchase-specific information to the manufacturer system 58 by way of the network 42, which may save the information to a database in the associated local information store 60 for future reference and for data redundancy. In some embodiments, the manufacturer system 54 may forward the received information to the information processor 44 or to the central information store 46.

In this example, the manufacturer system 58 may also send to a database in the central information store 46 by way of the network 42 general and detailed product information regarding the purchased vehicle model. For example, the manufacturer system 58 may forward general maintenance recommendations and requirements regarding the automobile model, along with variable or alternative maintenance recommendations, for example, based on multiple thresholds specific to the vehicle ambient operating climate and ambient operating temperature. For example, the maintenance recommendations for engine fluids, such as oil and antifreeze, may be variable depending on the climate and temperatures at which the automobile is operated.

When the vehicle purchaser takes the automobile to a service provider, such as, for example, a third party automobile service center that is not affiliated with the manufacturer, the distributor or the car dealer, user information and use context information may be transferred, for example, from a mobile user device 64, such as, for example, the purchaser's mobile phone or the a vehicle onboard information system, to a stationary user device 62, such as, for example, a vehicle diagnostic tool or a desktop personal computer associated with the service center.

The stationary user device 62 may forward the user information and use context, along with manually entered product information, for example, regarding the make and model of the automobile, and the service center location, to the information processor 44 along with a request for use-oriented information, such as, for example, engine fluid maintenance recommendations relevant to the local climate and recent or forecasted ambient temperatures.

In response, the information processor 44 may access variable maintenance recommendations in a database of the central information store 46, and select detailed maintenance recommendations or modify general maintenance recommendations to formulate use-oriented information in the form of specific, individualized engine fluid maintenance recommendations relevant to the local climate and ambient temperatures. For example, the use-oriented maintenance recommendations may recommend a relatively low viscosity oil, along with relatively concentrated antifreeze during the winter in a cold climate location.

A person of ordinary skill in the art will readily apprehend that an embodiment of the present invention may be combined with other relevant technologies to improve or enhance the quality or efficiency of the user experience. For example, the vehicle onboard information system may record over a period of time, such as, for example, the interval since the previous engine fluid maintenance, additional use context information, such as, for example, the vehicle ambient operating temperature, oil temperature, engine coolant temperature, vehicle operation time, average vehicle speed, or the like, and provide this information directly or indirectly over the network 42 to the information processor 44 for use in tailoring maintenance recommendations or requirements to the specific use context of the vehicle.

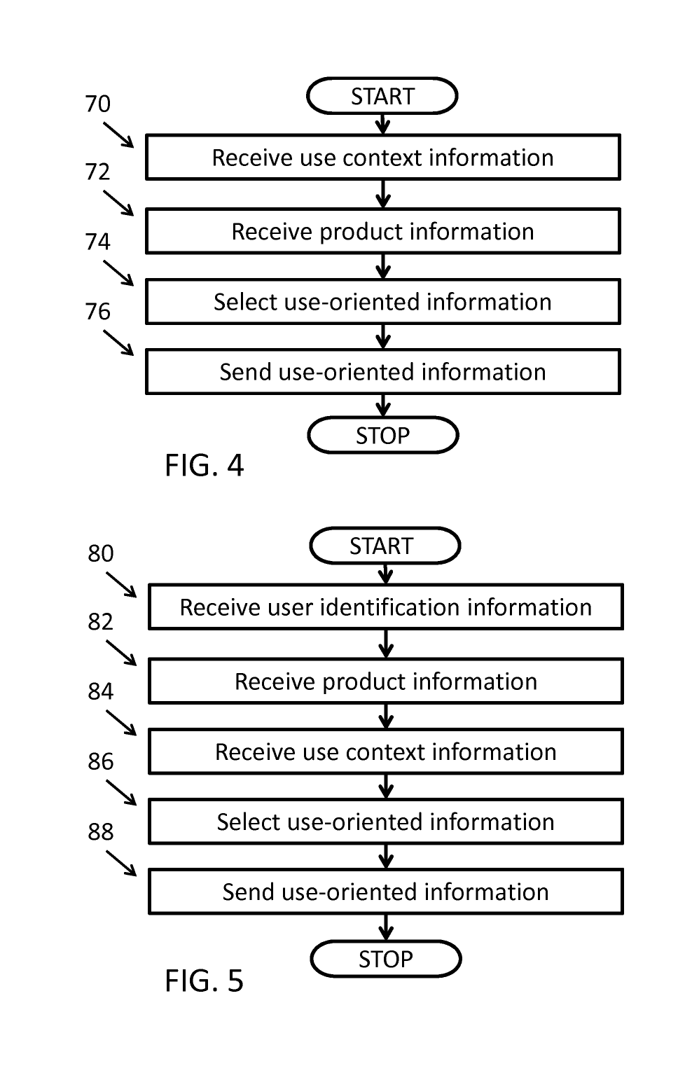

FIG. 4 is a flow diagram that outlines a method for generating or modifying use-oriented information. Use context information may be received in block 70. Product or service information may be received in block 72. Use-oriented information may be selected or modified in block 74. The use-oriented information may be sent to a user or consumer in block 76.

As a specific example of the method of FIG. 4, the location or altitude of a microwavable popcorn product purchaser's home may be received in block 70, and alternative cooking times based on altitude may be received in block 72. In block 74, the cooking time corresponding to the purchaser's home altitude may be selected. In block 76, the specific cooking time corresponding to the purchaser's home altitude may be sent to the purchaser.

FIG. 5 also provides a method for generating or modifying use-oriented information. User information, such as, for example, a user profile or user preferences, may be received in block 80. Product or service information may be received in block 82. Use context information may be received in block 84. Use-oriented information may be selected or modified in block 86. The use-oriented information may be sent to a user or consumer in block 88.

As a specific example of the method of FIG. 5, user information, such as, for example, the name of an automobile owner/operator, may be received in block 80. Product information, such as, for example, alternative extended warranty service information that varies with regard to the specific location at which the vehicle is based, may be received in block 82.

For example, the product information may indicate that the manufacturer or another warranty provider offers a 11-year/110,000 mile extended warranty coverage option for drivetrain components under a particular warranty plan with respect to personal vehicles whose operation is based Tucson, Arizona, based in part on the dry, relatively low humidity and warm temperatures, but only a 9-year/90,000 mile extended warranty coverage option for drivetrain components under the equivalent warranty plan with respect to vehicles operated in Portland, Me., based in part on the local salt water environment with relatively high humidity and cool temperatures.

The automobile owner/operator may provide information regarding the location where operation of the vehicle is based, and this use context information may be received in block 84. In this example, after receipt of use context information in block 84 indicating a vehicle owner's home and the base of operation for the owner's personal vehicle is Portland, Me., and receipt of the product information above, use-oriented information, such as, for example, the applicable 10-year /100,000 mile extended warranty coverage for a drivetrain component of the owned automobile model that corresponds to the owner's home location, may be selected in block 86.

Alternatively, a general warranty coverage, such as, for example, 10-year/100,000 mile coverage, may be modified, such as, for example, by an offset factor of negative 1 year/negative 10,000 miles, to formulate a use-oriented 9-year/90,000 mile extended warranty coverage, in block 86. In either the case of selecting or modifying the use-oriented information, the use-tailored 9-year/90,000 mile warranty coverage may be sent to the owner in block 88.

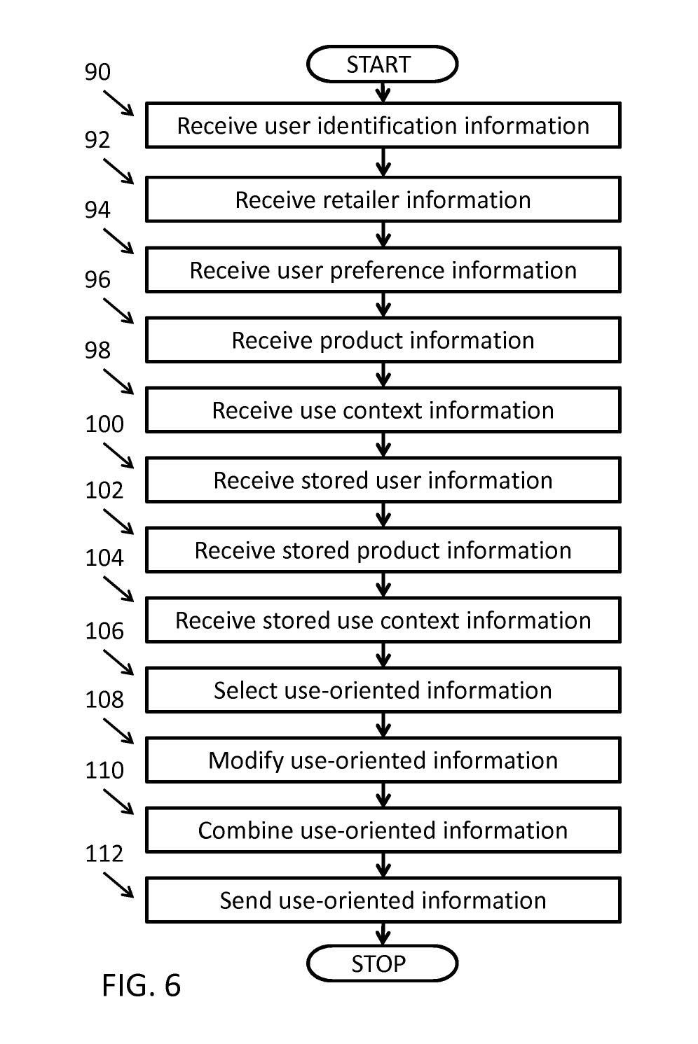

FIG. 6 discloses an additional method for generating or modifying use-oriented information. User identification information, such as, for example, a user's name, address and phone number, may be received in block 90. Seller information, such as, for example, a retailer name and location, may be received in block 92. User preference information may be received in block 94, and product information may be received in block 96. Use context information may be received in block 98. Additional stored user information stored use context information and stored use context information, may be received, for example, from one or more databases, in block 100, block 102 and block 104, respectively.

Based in part or all of the received information, use-oriented information may be selected, such as, for example, from among general product information, in block 106, and in block 108 use-oriented information may be modified, such as, for example, the modification of basic or default information with a variable offset value to formulate tailored use-oriented information.

In block 108, use-oriented information may be combined, for example, combining use-oriented information from multiple sources including, for example, a manufacturer or a distributor, or combining use-oriented information with general product information or information not related to the product. The resultant use-oriented information may be sent to a user or consumer in block 88.

As an applied example of the method of FIG. 6, the name of a purchaser of a variable 6/12 Volt (V) direct current accessory charger with a dual universal serial bus (USB) interface for use in a vehicle lighter receptacle may be received in block 90. A user preference, such as, for example, a preferred use with 12-V accessories, may be received in block 94.

In this example, the power pins of each of the two USB connectors are wired differently, connector “A” according to the wiring scheme of accessory manufacturer “A,” and connector “B” according to the wiring scheme of accessory manufacturer “B.” Thus, in block 96, product information regarding which of the two USB connectors corresponds to each accessory manufacturer may be received.

Use context information, such as, for example, that the charger is to be used with accessories made by manufacturer “A,” may be received in block 98. Additional stored user information, stored product information, and stored use context information, such as, for example, information previously saved by the charger distribution center upon receipt from the retailer that sold the charger to the purchaser, may be received at block 100, block 102 and block 104, respectively. In this example, information regarding the make and model of the purchaser's personal vehicle may be received in block 104.

In block 104, product use instructions for use with 12-V accessories may be selected, and in block 108 the instructions may be modified to convey instructions for use of the specific USB connector wired according to the wiring scheme of manufacturer “A.” The tailored instructions may be combined, in block 110, with the user manual for the purchaser's make and model of vehicle. An customized copy of the vehicle user manual including specific instructions for use of the USB accessory charger with 12-V accessories made by manufacturer “A” may be sent to the purchaser's mobile phone in block 112.

The flowchart and block diagrams in the Figures illustrate the architecture, functionality, and operation of possible implementations of systems, methods and computer program products according to various embodiments of the present invention.

In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for generating or modifying use-oriented information, comprising:
receiving a use context; and
selecting use-oriented product information, based at least in part on the use context.

2. The method of claim 1, wherein the use context comprises at least one of a location, an altitude indication, a climate definition, a season indication, a weather condition, an environment condition, an ambient temperature condition, an ambient pressure condition, a time indication, a product use combination.

3. The method of claim 1, wherein the use-oriented product information comprises a product use instruction.

4. The method of claim 1, further comprising:
receiving a product identification; and
selecting the use-oriented product information based at least in part on the product identification.

5. The method of claim 1, further comprising:
receiving a user identification; and
selecting the use-oriented product information based at least in part on the user identification.

6. The method of claim 1, further comprising sending the use-oriented product information to a user device.
